(19) United States
(12) Patent Application Publication
(10) Pub. No.: US 2008/0314946 A1
(43) Pub. Date: Dec. 25, 2008

(54) Sports tailgator grill/carrier

(76) Inventor: James Carson Owenby, Texarkana, AR (US)

Correspondence Address: James C Owenby, 3201 Owenby Drive, Texarkana, AR, 71854, US

(21) Appl. No.: 12/157,966

(22) Filed: Jun. 16, 2008

Related U.S. Application Data
(60) Provisional application No. 60/936,817, filed on Jun. 25, 2007.

(51) Int. Cl. B60R 9/06; A47J 37/06

(52) U.S. Cl. 224/487; 224/488; 126/25 R

(57) ABSTRACT

Tail Gator Grills/Carrier is the first tail gate grilling unit that is a combination tail gate grill and a luggage carrier, that can be used as a table when grilling and where the grills can be removed so the base can be used as a luggage carrier.

### CROSS-REFERENCE TO RELATED APPLICATIONS

There is no nonprovisional patent reference but there is a Provisional patent reference Application No. 60/936,817, Confirmation NO. 6401.

### STATEMENT REGARDING FEDERALLY SPONSORED RESEARCH OR DEVELOPMENT

“NOT APPLICABLE”

### REFERENCE TO A MICROFICHE APPENDIX

“NOT APPLICABLE”

### BACKGROUND OF THE INVENTION

The field of endeavor of this invention is portable grilling while tail gating with the option of removing the grills and using the base as a luggage carrier.

The prior problem with tailgate grilling is the fact that you have to load ever thing in the back of your vehicle and this takes up a lot of space also you have to carry a separate table, unlike other tail gate grills you can only cook on, with this one you can remove the grills and use it as a luggage carrier.

### BRIEF SUMMARY OF THE INVENTION

The general idea of the invention is how convenient it makes tail gate grilling and the fact you can also remove the grills and still use the base as a luggage carrier. The whole unit slides into your receiver on the back of your vehicle. While the grills are on they extend out away from the unit for cooking purposes where you can also use the base for a table.

### BRIEF DESCRIPTION OF SEVERAL VIEWS OF THE DRAWING

FIG. 1 is a top view of the grills and carrier with the grills folded up and ready to travel.

FIG. 2 is a side view of the grills and carrier with the grills folded up and ready to travel.

FIG. 3 is a back view of the grills and carrier with the grills half way unfolded (at 90 Degrees) when fully unfolded they would be at 180 degrees and ready to use.

FIG. 4 is a back view of the grills and carrier with the grills unfolded 180 degrees And extended out for grilling at this point you can also open the tailgate on your truck or S.U.V.

FIG. 5 is a back view of the carrier (with grills removed) to be used as a luggage carrier Only.

FIG. 6 is a side view of the carrier (with grills removed) to be used as a luggage carrier Only.

### DETAILED DESCRIPTION OF THE INVENTION

The tail gator/carrier is made up of two main items, one is the base, this is the carrier portion of the unit see FIG. 5 & 6. It is also the portion of the unit that slides into the hitch receiver on the vehicle, the base or carrier portion of the unit also holds the connection device to attach the grills (one on each side).

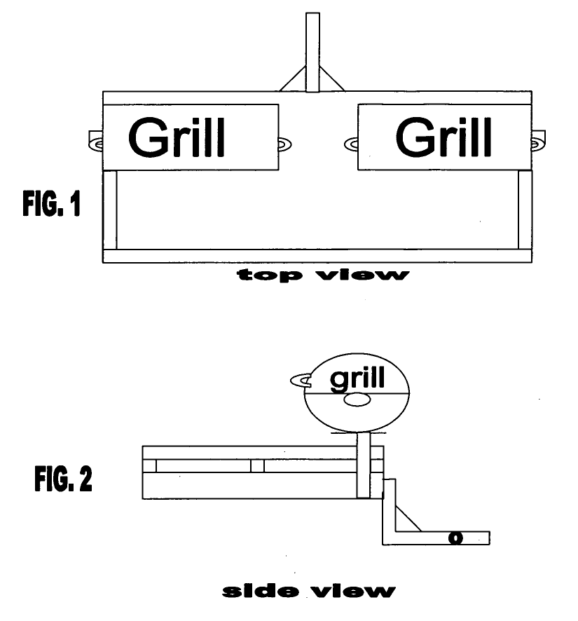

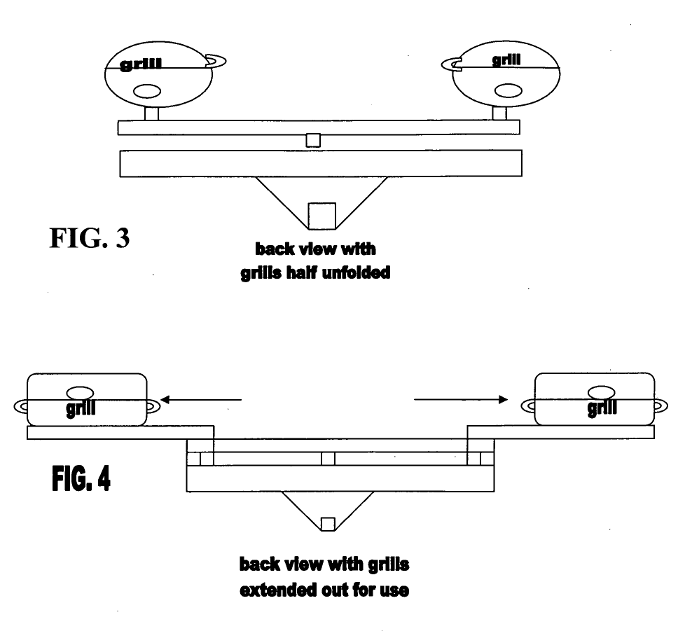

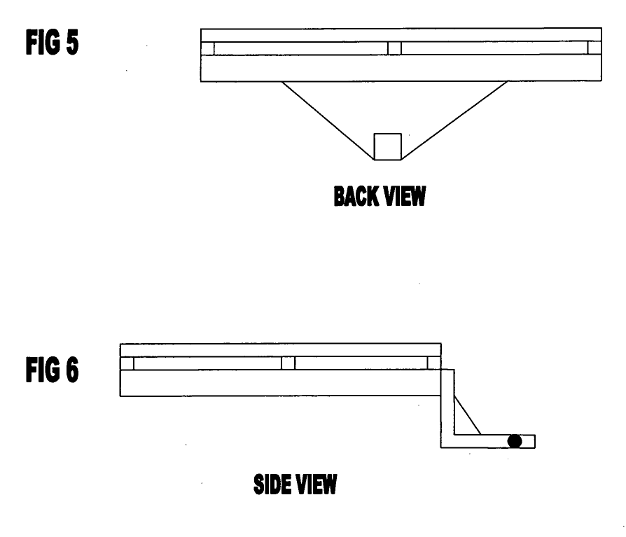

The second item are the grills one on each side, the grills have a device that is a slip connection that you can connect and disconnect the grills quickly. FIG. 1 is the top view of the carrier with the grills folded up for transporting, FIG. 2 is a side view of carrier With the grills folded up for transporting, FIG. 3 is a back view of the carrier and grills with the grills half way unfolded or turned 90 degrees from folded position, they would be unfolded a full 180 degrees to be used, FIG. 4 is a back view of the carrier and grills with the grills fully rotated to 180 degrees and fully extended out for use and at this position the grills are out of the way where the tail gate can be lowered, FIG. 5 is a back view of the carrier with the grills removed and ready to be used as a luggage carrier only, FIG. 6 is a side view of the carrier with the grills removed and ready to be used as a Luggage carrier only.

1. The Sports Tailgator Grill/Carrier has three functions, one is the base unit that connects to your receiver on the back of the vehicle and can be used as a luggage carrier,
The second use is a tailgate grill for cooking where the grills attach to the luggage carrier and the grills rotate 180 degrees from lock down position to the grilling position,
The third use is while the unit is together and in the grilling position you can use the base or luggage carrier as a table while you are grilling.
